(19) United States
(12) Patent Application Publication
(10) Pub. No.: US 2005/0141050 A1
(43) Pub. Date: Jun. 30, 2005

(54) Method and system to compensate for image size in multifunction printer with scanning function

(76) Inventor: Yong-kwon Kim, Cheonan-si (KR)

Correspondence Address: STANZIONE & KIM, LLP, 1740 N STREET, N.W., FIRST FLOOR, WASHINGTON, DC, 20036, US

(21) Appl. No.: 11/012,255

(22) Filed: Dec. 16, 2004

(30) Foreign Application Priority Data
Dec. 26, 2003 (KR) 2003-97803

(51) Int. Cl. G06F 15/00

(52) U.S. Cl. 358/474; 358/1.2; 358/1.9

(57) ABSTRACT

An image size compensating system of a multifunction printer includes a scanning unit to generate scan data obtained by scanning a reference document and a copy of the reference document, a system control unit to extract scan information on widths and lengths of the reference document and the copy from the scan data, and a printer engine to receive the scan information from the system control unit and to control a main motor controlling a length of a print image and a polygon motor controlling a width of the print image so that sizes of the reference document and the copy are identical to each other.

### CROSS-REFERENCE TO RELATED APPLICATIONS

This application claims the priority of Korean Patent Application No. 2003-97803, filed on Dec. 26, 2003, in the Korean Intellectual Property Office, the disclosure of which is incorporated herein in its entirety by reference.

### BACKGROUND OF THE INVENTION

1. Field of the Invention

The present general inventive concept relates to a method and apparatus to compensate for an image size in a multifunction printer with a scanning function, and more particularly, to a method and apparatus, which can make a size of a print image of a print document identical to that of an image of an original document by controlling a main motor to adjust a length of the print image and a polygon motor to adjust a width of the print image.

2. Description of the Related Art

In a multifunction printer with a scanning function, an image size of a print document is not generally identical to that of an original document. This is caused by the interrelation between motors that control a width and a length of the documents.

Korean Patent Laid-Open Publication No. 2003-4799 discloses a document magnifying/printing method of a multifunction printer. According to this magnifying/printing method, a left and right ratio and an overall scan ratio with respect to a current scanned area detected by a black patch are compared to provide an accurately magnified scan image. However, this magnifying/printing method does not disclose a control method of main and polygon motors.

### SUMMARY OF THE INVENTION

The present general inventive concept provides a method and apparatus, which can make a size of a print image of a print document identical to that of an image of an original document by controlling a main motor controlling a length of the print image and a polygon motor controlling a width of the print image.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing, there is provided an image size compensating system of a multifunction printer, the system comprising a scanning unit to generate scan data obtained by scanning a reference document and a copy of the reference document, a system control unit to extract scan information on widths and lengths of the reference document and the copy from the scan data, and a printer engine to receive the scan information from the system control unit and to control a main motor controlling (adjusting) a length of a print image and a polygon motor controlling (adjusting) a width of the print image so that the sizes of the reference document and the copy are identical to each other.

The system control unit may comprise a control unit to generate a motor RPM control command for controlling RPMs of the main and polygon motors based on the scan information on the widths and lengths of the reference document and the copy, and a memory to store the RPMs of the main and polygon motors and to update the RPMs.

The control unit may increase or reduce the RPM of the polygon motor first to make the widths of the reference document and the copy identical to each other when the widths and lengths of the reference document are different from those of the copy, considering a length variation of the copy according to an RPM variation of the polygon motor.

When the length of the reference document is identical to that of the copy, the control unit may increase the RPMs of the main and polygon motors at a first predetermined rate according to a difference between the widths of the reference document and the copy in a case where the width of the copy is less than that of the reference documents, may reduce the RPM of the main and polygon motors at a second predetermined rate according to the difference between the widths of the reference document and the copy in a case where the width of the copy is greater than that of the reference document, and may maintain the current RPM of the polygon motor in a case where the width of the copy is identical to that of the reference document.

When the width of the reference document is identical to that of the copy, the control unit may increase the RPM of the main motor at a third predetermined rate according to a difference between the lengths of the reference document and the copy in a case where the length of the copy is less than that of the reference documents, may reduce the RPM of the main motor at a fourth predetermined rate according to the difference between the lengths of the reference document and the copy in a case where the length of the copy is greater than that of the reference document, and may maintain the current RPM of the polygon motor in a case where the length of the copy is identical to that of the reference document.

The printer engine may comprise an engine control unit to receive a motor RPM control command from the system control unit to control the main and polygon motors such that the sizes of the reference document and the copy are identical to each other, the main motor controlling the length of the print image according to the motor RPM control command transmitted from the engine control unit, and a laser scanning unit including the polygon motor controlling the width of the print image according to the motor RPM control command from the engine control unit.

The foregoing and/or other aspects and advantages of the present general inventive concept may also be achieved by providing an image size compensating method comprising storing scan information on sizes of a reference document and a copy of the reference document after scanning the reference document and the copy, and compensating an image size by controlling a main motor to adjust a length of a print image and a polygon motor to adjust a width of the print image such that the sizes of the reference document and the copy are identical to each other according to the scan information.

The image size compensating method may further comprise identifying if the sizes of the copy and the reference document are identical to each other by scanning the reference document and printing a scanned image of the reference document to make the copy and scanning the copy.

The storing of the scan information may comprise storing first scan information on a length and a width of the reference document by scanning the reference document, and storing second scan information on a length and a width of the copy by scanning the copy of the reference document.

The compensating of the an image size may comprise controlling RPMs of the polygon and main motors by comparing the width of the reference document with the width of the copy of the reference document, and controlling the RPMs of the polygon and main motors by comparing the length of the reference document with the length of the copy of the reference document.

when the length of the reference document is identical to that of the copy, the RPMs of the main and polygon motors may be increased at a first predetermined rate according to a difference between the widths of the reference document and the copy in a case where the width of the copy is less than that of the reference documents, the RPMS of the main and polygon motors may be reduced at a second predetermined rate according to the difference between the widths of the reference document and the copy in a case where the width of the copy is greater than that of the reference document, and the current RPM of the polygon motor may be maintained in a case where the width of the copy is identical to that of the reference document.

When the width of the reference document is identical to that of the copy, the RPM of the main motor may be increased at a third predetermined rate according to a difference between the lengths of the reference document and the copy in a case where the length of the copy is less than that of the reference documents, the RPM of the main motor may be reduced at a fourth predetermined rate according to the difference between the lengths of the reference document and the copy in a case where the length of the copy is greater than that of the reference document, and the current RPM of the polygon motor may be maintained in a case where the length of the copy is identical to that of the reference document.

The compensating of the image size may further comprise reducing or increasing an RPM of the polygon motor to make the widths of the reference document and the copy identical to each other when the widths and lengths of the reference document are different from those of the copy, considering a length variation of the copy according to an RPM variation of the polygon motor.

The RPMs of the main and polygon motors may be updated.

The first, second, third, or fourth predetermined rate may be determined by a test or simulation.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an image size compensation system according to an embodiment of the present general inventive concept;

FIG. 2 is a block diagram illustrating a system control unit of FIG. 1;

FIG. 3 is a block diagram illustrating a printer engine of FIG. 1;

FIG. 4 is a flowchart illustrating an image size compensating method according to another embodiment of the present general inventive concept;

FIG. 5 is a flowchart illustrating a scan information storing operation S400 of FIG. 4;

FIG. 6 is a flowchart illustrating an image size compensating operation S401 of FIG. 4;

FIG. 7 is a flowchart illustrating an identifying operation S402 of FIG. 4; and

FIG. 8 is a schematic view illustrating a position of a reference document to be loaded according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

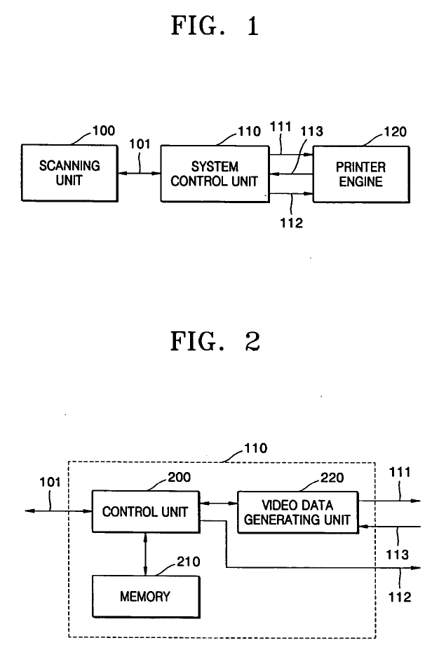

FIG. 1 is a block diagram illustrating an image size compensating system according to an embodiment of the present general inventive concept.

Referring to FIG. 1, an image size compensating system comprises a scanning unit 100, a system control unit 110, and a printer engine 120.

The scanning unit 100 scans a document to generate scan data 101 including a width and a length of the document, and transmits the scan data 101 to a system control unit 110.

The system control unit 110 receives the scan data 101 from the scanning unit 100, extracts information on the width and length of a scanned image of the document from the scan data 101, controls RPMs of main and polygon motors of the printer engine 120 to adjust an image size of a print document to that of an original document, and transmits video data 111 to the printer engine 120.

The printer engine 120 receives the video data 111 from the system control unit 110, prints the scanned image by transferring the scanned image to a photo drum using a laser scanning unit, and transmits a beam detect (BD) signal 113 eradiated from the laser scanning unit to the system control unit 110. The system control unit 110 transmits a motor RPM control command 112 to the printer engine 120 according to the extracted information on the width and the length of the scanned image of the document.

FIG. 2 is a block diagram illustrating the system control unit 110 of the image size compensating system of FIG. 1.

As shown in FIGS. 1 and 2, the system control unit 110 comprises a control unit 200, a memory 210, and a video data generating unit 220.

The control unit 200 receives the scan data 101 including the width and the length of the scanned image of the document from the scanning unit 100, generates the motor RPM control command 112 for the main and polygon motors according to the width and the length, transmits the motor RPM control command 112 to the printer engine 120 and the video data 111 to the printer engine 120 through the video data generating unit 220. The memory 210 stores current RPM values of the main and polygon motors, updates the RPM values in accordance with a difference between an image of the original document and an image of the print document, and stores scan information on an image size of the document scanned by the scanning unit 100.

The video data generating unit 220 receives the scan data 200 from the control unit 200 to generate the video data 111 for controlling the printer engine in an on/off method and transmits the video data 111 to the printer engine 120.

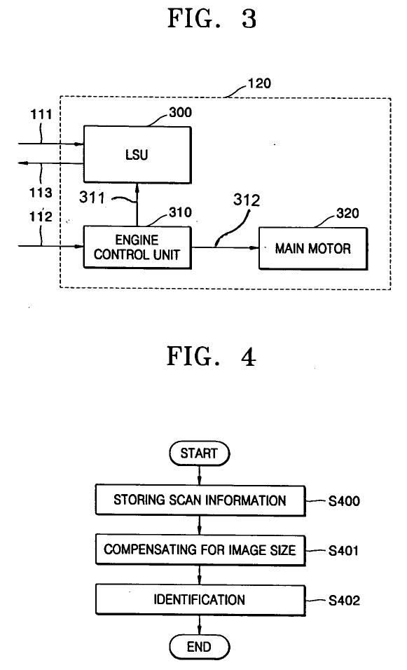

FIG. 3 is a block diagram illustrating the printer engine 120 of FIG. 1.

Referring to FIG. 3, the printer engine 120 comprises a laser scanning unit 300 including the polygon motor, an engine control unit 310, and the main motor 320.

The laser scanning unit 300 receives the video data 111 from the video data generating unit 220, prints the scanned image by transferring the same to the photo drum, generates the BD signal 111 in advance of printing a line of dots corresponding to the scanned image, and transmits the BD signal 113 to the system control unit 110. The polygon motor (not shown) of the laser scanning unit 300 controls the width of the image of the print document according to a first motor control signal 311 transmitted from the engine control unit 310. The engine control unit 310 receives the motor RPM control command 112 for the main and polygon motors from the control unit 200 and drives the main and polygon motors according to the motor RPM control command.

The main motor 320 receives a second motor control command 312 from the engine control unit 310 to control the length of the image of the print document. The main motor 320 may be a motor to drive a document transfer roller or a document feeding roller.

FIG. 4 shows a flowchart illustrating an image size compensating method according to another embodiment of the present general inventive concept.

The image size compensating method comprises a scan information storing operation S400, an image size compensating operation S401, and an identifying operation S402.

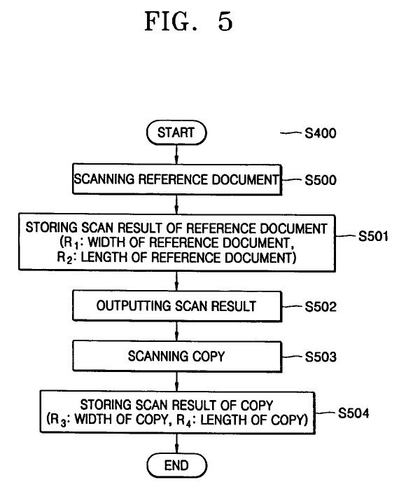

In the scan information storing operation S400, a reference document and a copy are scanned, and scan information on an image size of the document and the copy are stored. This will be described more in detail later with reference to FIG. 5.

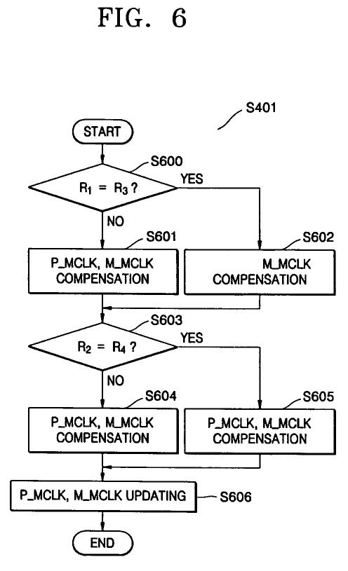

In the image size compensating operation S401, sizes (widths and lengths) of the reference document and the copy are compared with each other, and RPMs of the main and polygon motors are controlled according to the comparison. This will be described more in detail later with reference to FIG. 6.

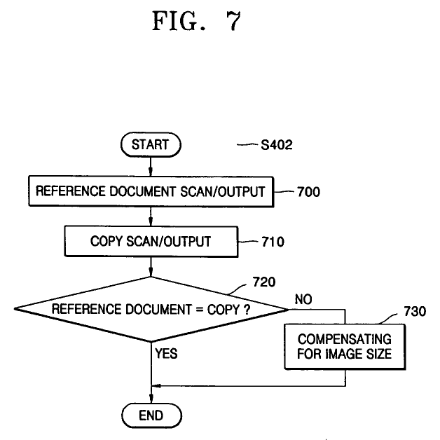

In the identifying operation S402, the copy is scanned again according to the RPMs of the main and polygon motors, and the compensated results are identified. This will be described more in detail later with reference to FIG. 7.

FIG. 5 shows a flowchart illustrating the scan information storing operation S400 of FIG. 4.

The scan information storing operation S400 comprises a reference document scan operation S500, a reference document scan result storing operation S501, a scan result output operation S502, a copy scan operation S503, and a copy scan result storing operation S504.

In the reference document scan operation S500, the scanning unit 100 scans the reference document to generate scan information including a width and a length of the reference document.

In the reference document scan result storing operation S501, the scan information of the reference document is stored in the memory 210. The width and length of the reference document are respectively R1 and R2, and the width and length of the copy are respectively R3 and R4.

In the scan result output operation S502, the video data of the reference document is generated and a copy of the reference document is printed by transferring the video data to the photo drum using the on/off method.

In the copy scan operation S503, the scanning unit 100 scans the copy to generate scan information including the width and length of the copy.

In the copy scan result storing operation S504, the scan result of the copy is stored in the memory 210.

FIG. 6 shows the image compensating operation S401 of FIG. 4.

Referring to FIGS. 2 and 6, the image compensating operation S401 comprises a width comparing operation S600, RPM compensating operations S601 and S602, a length comparing operations S603, RPM compensating operations S604 and S605, and an RPM updating operation S606.

In the width comparing operation S600, sizes of the reference document and the copy are extracted from the stored scan information, and the width of the reference document is compared with the width of the copy.

In the RPM compensating operations S601 and S602, RPMs P_MCLK and M_MCLK of the polygon and main motors are compensated according to the comparison results between the widths of the reference document and the copy. That is, when the widths of the reference document and the copy are identical to each other (R1=R3), since there is no need of varying the RPM P_MCLK of the polygon motor, the RPM P_MCLK is not compensated and updated. Therefore, by comparing the lengths of the reference document and the copy, the RPM M_MCLK of the main motor is controlled.

In the length comparing operation S603, the lengths of the reference document and the copy are compared with each other using the stored scan information.

In the RPM compensating operations S604 and S605, RPMs M_MCLK and P_MCLK of the main and polygon motors are controlled according to the comparison results of the RPM compensating operation S603.

In the RPM updating operation S606, the compensated RPMs of the main and polygon motors are updated and stored in the memory 210.

There may be nine cases according to the widths and lengths of the documents.

(1) When R1 is identical to R3 (R1=R3), there are following three cases.

(1a) When R2 is identical to R4 (R2=R4), since the sizes of the reference document and the copy are identical to each other, the RPMs of the main and polygon motors are not compensated.

(1b) When R2 is greater than R4 (R2>R4), the RPMs of the motors are compensated. That is, since the length R4 of the copy is less than the length R2 of the reference document, the RPM M_MCLK of the main motor is increased by, for example, K2(R2−R4), where the K2 is a proportion constant that can be obtained by trial and error and experiments.

(1c)) When R2 is less than R4 (R2<R4), the RPMs of the motors are compensated. That is, since an image is increased in a lengthwise direction of the document, the RPM M_MCLK of the main motor is reduced by, for example, K2(R2−R4), to compensate for the increased image in the lengthwise direction.

(2) When R1 is greater than R3 (R1>R3), there are following three cases.

(2a) When R2 is identical to R4 (R2=R4), since the width of the copy is less than that of the reference document while the lengths of the reference document and the copy are identical to each other, the RPM P_MCLK of the polygon motor must be increased. At this point, the width of the print image may become reduced as the RPM P_MCLK of the polygon motor is increased. Therefore, the RPM M-MCLK of the main motor may need to be increased.

At this point, when the widths of the reference document and the copy are identical to each other (R1=R3), it may be possible to independently adjust the length of the print image by compensating for only the RPM M_MLCK of the main motor without varying the RPM P_MLCK of the polygon motor. However, when the lengths of the reference document and the copy are identical to each other and the widths of the reference document and the copy are different from each other, it may be impossible to independently adjust the width of the print image by compensating only the RPM P_MLCK of the polygon motor. This is caused by an interrelation between the main motor controlling an advancing speed of the print document and the length of the print image, the poly motor controlling the width of the print image, and the video data inputted into the printer engine.

Therefore, considering the interrelation, after the RPM P_MCLK of the polygon motor, which is compensated with respect to a width difference, is first calculated, the RPM M_MCLK of the main motor must be compensated with respect to a length difference with reference to the calculated RPM of the polygon motor.

(2b) When R2 is greater than R4 (R2>R4), since the width and length of the copy are less than those of the reference document, the RPM P_MCLK of the polygon motor must be increased to increase the length of the print image. At this point, the length of the print image may become reduced as the RPM P_MCLK of the polygon motor is increased. Therefore, the RPM M-MCLK of the main motor needs to be increased at a predetermined rate according to a sum of a compensation of the reduced image length and a difference of the lengths of the reference document and the copy.

That is, the RPM P_MCLK of the polygon motor is increased according to K1 (R1−R3) and the RPM M_MCLK of the main motor is increased according to K1 (R1−R3)+K2(R2−R4) where K1 and K2 are a proportion constant that can be obtained by trial and error and experiments.

(2c) When R2 is less than R4 (R2<R4), since the width of the copy is less than that of the reference document while the length of the copy is greater than that of the reference document, the RPM P_MCLK of the polygon motor is increased. At this point, the length of the print image may be increased. Accordingly, the RPM M-MCLK of the main motor may need to be increased or reduced according to the increased length of the print image.

That is, the RPM P_MCLK of the polygon motor is increased by K1 (R10−R3) and the RPM M_MCLK of the main motor is increased or reduced by K1 (R1−R3)+K2(R2−R4).

(3) When R1 is less than R3 (R1<R3), there are following three cases.

(3a) When R2 is identical to R4 (R2=R4), since the width of the copy is greater than that of the reference document while the lengths of the reference document and the copy are identical to each other, the RPM P_MCLK of the polygon motor must be reduced. At this point, since the width of the print image may be increased, the RPM M-MCLK of the main motor may need to be reduced according to the increased width of the print image.

That is, the RPM P_MCLK of the polygon motor is reduced by K1 (R1−R3) and the RPM M_MCLK of the main motor is reduced by K1 (R1−R3)+K2(R2−R4).

(3b) When R2 is less than R4 (R2<R4), since the width of the copy is greater than that of the reference document while the length of the copy is less than that of the reference document, the RPM P_MCLK of the polygon motor is reduced. At this point, since the length of the print image is increased, the RPM M-MCLK of the main motor must be increased or reduced considering the compensation of the RPM M_MCLK of the main motor.

That is, the RPM P_MCLK of the polygon motor is reduced by K1 (R1−R3) and the RPM M_MCLK of the main motor is increased or reduced by K1 (R1−R3)+K2(R2−R4).

(3c) When R2 is less than R4 (R2<R4), since the width and length of the copy is greater than those of the reference document, the RPM P_MCLK of the polygon motor is reduced. At this point, since the length of the print image is increased, the RPM M-MCLK of the main motor must be reduced considering the increased width and the difference between the R2 and R4.

That is, the RPM P_MCLK of the polygon motor is increased by K1 (R1−R3) and the RPM M_MCLK of the main motor is reduced by K1 (R1−R3)+K2(R2−R4).

Table 1 shows the above-described nine cases to control the main and polygon motors.

In Table 1, K2 indicates a proportion constant of the main motor controlling the lengths of the documents and K1 indicates a proportion constant of the polygon motor controlling the widths of the documents.

TABLE 1

| | R1 = R3 | R1 > R3 | R1 < R3 |
|---|---|---|---|
| R2 = R4 | Size of reference | RPM of polygon motor is | RPM of polygon motor is |
| | document is | increased by K1(R1 − R3). | reduced by K1(R1 − R3). |
| | identical to that of | RPM of main motor is | RPM of main motor is |
| | copy | increased by K1(R1 − R3) | reduced by K1(R1 − R3) |
| R2 > R4 | RPM of main motor | RPM of polygon motor is | RPM of polygon motor is |
| | is increased by | increased by K1(R1 − R3). | reduced by K1(R1 − R3). |
| | K2(R2 − R4) | RPM of main motor is | RPM of main motor is |
| | | increased by K1(R1 − R3) + K2 | increased or reduced by |
| | | (R2 − R4) | K1(R1 − R3) + K2(R2 − R4) |
| R2 < R4 | RPM of main motor | RPM of polygon motor is | RPM of polygon motor is |
| | is reduced by | reduced by K1(R1 − R3). | reduced by K1(R1 − R3). |
| | K2(R2 − R4) | RPM of main motor is | RPM of main motor is |
| | | reduced or increased by | reduced by K1(R1 − R3) + |
| | | K1(R1 − R3) + K2(R2 − R4) | K2(R2 − R4) |

FIG. 7 shows a flowchart illustrating the identifying operation S402 of FIG. 4.

Referring to FIG. 7, the identifying operation S402 comprises a reference document scan/output operation S700, a copy scan/output operation S710, a size comparison operation S720, and an image size compensation operation S730.

In the reference document scan/output operation S700, the reference document is scanned and outputted.

In the copy scan/output operation S710, the copy of the reference document is scanned and outputted.

In the size comparison operation S720, the sizes of the documents are extracted from the scan information of the reference document and the scan information of the copy, and the sizes are compared with each other to determine if the sizes are identical to each other.

In the image size compensation operation S730, when the sizes are not identical to each other, process is returned to operation S401 to compensate the RPMs of the main and polygon motors and thereby to compensate the image size.

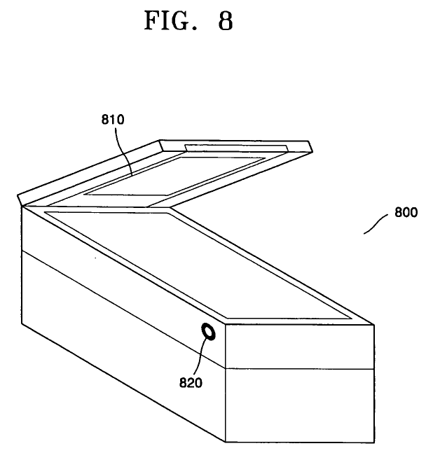

FIG. 8 shows a position of a reference document 810 loaded in a multifunction printer 8 according to another embodiment of the present general inventive concept.

Referring to FIG. 8, the reference document 810 is attached on a top of the multifunction printer 800 and is loaded in the multi printer by a button 820 provided on a side of the multifunction printer.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An image size compensating system used with a multifunction printer, comprising:
a scanning unit to generate scan data obtained by scanning a reference document and a copy of the reference document;
a system control unit to extract scan information on widths and lengths of the reference document and the copy from the scan data; and
a printer engine to receive the scan information from the system control unit and to compensate for an image size by controlling a main motor to adjust a length of a print image and a polygon motor to adjust a width of the print image so that the sizes of the reference document and the copy are identical to each other.

2. The image size compensating system of claim 1, wherein the system control unit comprises:
a control unit to generate a motor RPM control command to control RPMs of the main and polygon motors based on the scan information on the widths and lengths of the reference document and the copy; and
a memory to store the RPMs of the main and polygon motors and to update the RPMs.

3. The image size compensating system of claim 2, wherein the control unit increases or reduces the RPM of the polygon motor to make the widths of the reference document and the copy identical to each other when the widths and lengths of the reference document are different from those of the copy, according to a length variation of the copy according to an RPM variation of the polygon motor.

4. The image size compensating system of claim 2, wherein, when the length of the reference document is identical to that of the copy, the control unit:
increases the RPMs of the main and polygon motors at a first predetermined rate by a first difference between the widths of the reference document and the copy if the width of the copy is less than that of the reference documents;
reduces the RPM of the polygon motor at a second predetermined rate by a second difference between the lengths of the reference document and the copy if the length of the copy is greater than that of the reference document; and
maintains the RPM of the polygon motor if the width of the copy is identical to that of the reference document.

5. The image size compensating system of claim 2, wherein, when the width of the reference document is identical to that of the copy, the control unit:
increases the RPM of the main motor at a first predetermined rate according to a first difference between the lengths of the reference document and the copy if the length of the copy is less than that of the reference documents;
reduces the RPM of the main motor at a second predetermined rate according to a second difference between the lengths of the reference document and the copy if the length of the copy is greater than that of the reference document; and
maintains the current RPM of the polygon motor if the length of the copy is identical to that of the reference document.

6. The image size compensating system of claim 2, wherein the printer engine comprises:
an engine control unit to receive a motor RPM control command from the system control unit to control the main and polygon motors such that the sizes of the reference document and the copy are identical to each other;
the main motor to control the length of the print image according to the motor RPM control command transmitted from the engine control unit; and
a laser scanning unit including the polygon motor to control the width of the print image according to the motor RPM control command from the engine control unit.

7. An image size compensating method comprising:
storing scan information on sizes of a reference document and a copy of the reference document after scanning the reference document and the copy; and
compensating for an image size by controlling a main motor to adjust a length of a print image and a polygon motor to adjust a width of the print image according to the scan information, such that the sizes of the reference document and the copy are identical to each other according to the scan information.

8. The image size compensating method of claim 7, further comprising:
determining whether the sizes of the copy and the reference document are identical to each other by scanning the reference document to print a scanned image of the reference document as the copy and scanning the copy.

9. The image size compensating method of claim 7, wherein the storing of the scan information comprises:
storing first scan information on a length and width of the reference document by scanning the reference document; and
storing second scan information on a length and width of the copy by scanning the copy of the reference document.

10. The image size compensating method of claim 7, wherein the compensating of the image size comprises:
controlling RPMs of the polygon and main motors by comparing a width of the reference document with a width of the copy of the reference document; and
controlling RPMs of the polygon and main motors by comparing a length of the reference document with a length of the copy of the reference document.

11. The image size compensating method of claim 10, wherein, when the length of the reference document is identical to that of the copy,
the RPMs of the main and polygon motors is increased at a first predetermined rate according to a first difference between the widths of the reference document and the copy if the width of the copy is less than that of the reference documents;
the RPM of the polygon motor is reduced at a second predetermined rate according to a second difference between the lengths of the reference document and the copy if the length of the copy is greater than that of the reference document; and
the current RPM of the polygon motor is maintained if the width of the copy is identical to that of the reference document.

12. The image size compensating method of claim 10, wherein, when the width of the reference document is identical to that of the copy,
the RPM of the main motor is increased at a first predetermined rate according to a first difference between the lengths of the reference document and the copy if the length of the copy is less than that of the reference documents;
the RPM of the main motor is reduced at a second predetermined rate according to a second difference between the lengths of the reference document and the copy if the length of the copy is greater than that of the reference document; and
the current RPM of the polygon motor is maintained if the length of the copy is identical to that of the reference document.

13. The image size compensating method of claim 10, wherein the compensating for the image size further comprises reducing or increasing an RPM of the polygon motor to make the widths of the reference document and the copy identical to each other when the widths and lengths of the reference document are different from those of the copy, according to a length variation of the copy according to an RPM variation of the polygon motor.

14. The image size compensating method of claim 13, wherein the RPMs of the main and polygon motors are updated.

15. The image size compensating method of claim 12, wherein the first and second predetermined rates are determined by a test or simulation.

16. An image size compensating system used with an image forming apparatus, comprising:
a scanning unit to scan a first document, a second document, and a third document to generate first, second, and third scan data, respectively; and
a system control unit to extract scan information on a first width and a first length of a first image of the first document and a second width and a second length of a second image of the second document from the first and second scan data, and to adjust a third width and a third length of a third image of the third document according to the scan information.

17. The image size compensating system of claim 16, further comprising:
a printer engine to print the third image according to the adjusted third width and length.

18. The image size compensating system of claim 16, further comprising:
a printer engine having a laser scanning unit to adjust the third width, and a main motor to adjust the third length according to the scan information.

19. The image size compensating system of claim 16, wherein the scanning unit scans a fourth document to generate fourth data, and the system control unit extracts second scan information on the adjusted third width and length of the third image of the third document and adjusts a fourth width and a fourth length of a fourth image of the fourth document according to the second scan information.

20. The image size compensating system of claim 19, further comprising:
a memory to store the scan information and to update the scan information with the second scan information.

21. The image size compensating system of claim 19, further comprising:
a printer engine to print the third image and the fourth image according to the scan information.

22. The image size compensating system of claim 19, further comprising:
a printer engine to print the third image according to the scan information and to print the fourth image according to the second scan information.

23. The image size compensating system of claim 16, wherein the scan information comprises a difference between the first width and the second width and a second difference between the first length and the second length.

24. The image size compensating system of claim 16, further comprising:
a printer engine to print the first image of the first document,
wherein the scanning unit scans the printed first image as the second document to generate the second image of the second document.

25. The image size compensating system of claim 24, wherein the printer engine comprises:
a laser scan unit to form a print image corresponding to the third image according to the scan information; and
a main motor to feed a paper on which the print image is printed,
wherein the system control unit controls the laser scan unit to adjust the third width of the third image and the main motor to adjust the third length of the third image according to the scan information.

26. The image size compensating system of claim 24, wherein the printer engine prints the third image according to the scan information so that the third width of the printed third image is identical to the first width and length of the first image of the first document.

27. The image size compensating system of claim 16, wherein the image forming apparatus comprises a body and a cover rotatably coupled to the body, and the first document is fixedly mounted on the cover.

28. The image size compensating system of claim 27, wherein the second and third documents are not fixedly mounted on the cover but movably loaded on the body to be scanned by the scanning unit.

29. The image size compensating system of claim 27, wherein the image forming apparatus comprises a button mounted on a side of the body to control the scanning unit to scan the first document.

30. The image size compensating system of claim 16, wherein the image forming apparatus comprises a body, a cover rotatably coupled to the body and having the first document, and a button to control the scanning unit to scan the first document.

31. An image compensating system used with a printer, comprising:
a scanning unit to scan a first document, a second document, and a third document to generate first, second, and third scan data, respectively; and
a system control unit to extract scan information on a first dimension of a first image of the first document and a second dimension of a second image of the second document from the first and second scan data, and to adjust a third dimension of a third image of the third document according to the scan information.
